(19) United States
(12) Patent Application Publication
(10) Pub. No.: US 2015/0101527 A1
(43) Pub. Date: Apr. 16, 2015

(54) DUPLEX PARTIALLY CUTTING APPARATUS

(71) Applicant: LITEMAX ELECTRONICS INC., NEW TAIPEI CITY (TW)

(72) Inventor: JUNG-CHI LO, NEW TAIPEI CITY (TW)

(73) Assignee: LITEMAX ELECTRONICS INC., NEW TAIPEI CITY (TW)

(21) Appl. No.: 14/054,876

(22) Filed: Oct. 16, 2013

(51) Int. Cl. B26D 7/34; B26D 3/08; B26D 7/01; B26D 1/04

(52) U.S. Cl. CPC B26D 7/34; B26D 1/045; B26D 3/08; B26D 7/018
USPC 118/37; 83/169

(57) ABSTRACT

A duplex partially cutting apparatus, for cutting partially a panel from above and below, includes a frame, a panel fastening unit, a first partial cutting unit, a second partial cutting unit, and a plurality of electrostatic fans. The panel fastening unit is disposed on the frame to fix the panel. The first partial cutting unit is disposed on the frame and above the panel fastening unit to cut partially the panel from above. The second partial cutting unit is disposed on the frame and below the panel fastening unit to cut partially the panel from below. The electrostatic fans are disposed on the frame and correspond in position to a point of partial cut performed by the first partial cutting unit and the second partial cutting unit cut panel. The duplex partially cutting apparatus is advantageously conducive to reducing instances of alignment, alignment-induced errors, and manufacturing process duration.

### FIELD OF TECHNOLOGY

The present invention relates to duplex partially cutting apparatuses, and more particularly, to a duplex partially cutting apparatus for cutting partially a panel from above and below simultaneously.

### BACKGROUND

Conventional panels, such as LCD panels, OLED panels, and TP panels, are widely applicable to human beings' daily life nowadays. Depending on their place of use and their purpose of use, panels of specific dimensions are in demand. To this end, panel manufacturers manufacture the panels of specific dimensions by cutting large panels with a view to reducing manufacturing costs.

A conventional panel partially cutting process comprises the steps of: placing a large-sized panel at a first panel partially cutting apparatus and aligning the large-sized panel; performing a first partial cut on the large-sized panel from above by means of the first panel partially cutting apparatus; turning over the large-sized panel and placing the large-sized panel thus turned over at a second panel partially cutting apparatus; aligning the large-sized panel thus turned over by means of the second panel partially cutting apparatus; performing a second partial cut on the large-sized panel from above by means of the second panel partially cutting apparatus; and splitting the large-sized panel and sealing the cut-created edge of a desired one of resultant panels by means of a sealing unit of the second panel partially cutting apparatus. As indicated above, the conventional panel partially cutting process must be performed with two said panel partially cutting apparatuses and thus require aligning the large-sized panel on several consecutive occasions, thereby bringing inconvenience to the manufacturers, causing errors, incurring high manufacturing costs, and compromising the yield.

Furthermore, the conventional panel partially cutting process takes time to perform, and thus mass production can hardly be quick.

Furthermore, the conventional panel partially cutting process entails moving the large-sized panel between the two panel partially cutting apparatuses, and in consequence airborne foreign bodies and dust are likely to remain on the large-sized panel; as a result, finished panels are likely to be defective and susceptible to failure.

Accordingly, it is imperative to provide a duplex partially cutting apparatus whereby users carry out panel alignment less often and perform the panel partially cutting process quickly.

### SUMMARY

In view of the aforesaid drawbacks of the prior art, it is an objective of the present invention to provide a duplex partially cutting apparatus whereby users early out panel alignment less often to thereby prevent alignment-induced errors.

Another objective of the present invention is to provide a duplex partially cutting apparatus for cutting partially a panel from above and below simultaneously to thereby speed up the manufacturing process and increase the yield.

In order to achieve the above and other objectives, the present invention provides a duplex partially cutting apparatus for cutting partially a panel from above and below. The duplex partially cutting apparatus comprises a frame, a panel fastening unit, a first partial cutting unit, a second partial cutting unit, and a plurality of electrostatic fans.

The panel fastening unit is disposed on the frame. The panel fastening unit comprises: a first platform with a plurality of through holes thereon, the first platform being positioned proximate to the front side of the frame; a second platform having thereon a plurality of through holes and being positioned proximate to a rear side of the frame; a cutter movement space defined between the first platform and the second platform; a panel sucker disposed below the first platform and the second platform and being in communication with the through holes to take the panel by suction; at least two positioning element fixing holes disposed on the second platform; at least two panel positioning elements inserted into the positioning element fixing holes, respectively, to fix the panel in place; and a platform driver electrically connected to the second platform to drive the second platform to move forward and backward.

The first partial cutting unit disposed on the frame and including: a first cutter disposed above the panel fastening unit; and a first cutter driver electrically connected to the first cutter to drive the first cutter to move horizontally and vertically within the cutter movement space of the panel fastening unit.

The second partial cutting unit disposed on the frame and including: a second cutter disposed below the panel fastening unit and corresponding in position to the first cutter; and a second cutter driver electrically connected to the second cutter to drive the second cutter to move horizontally and vertically within the cutter movement space of the panel fastening unit.

The electrostatic fans are disposed on the frame and face the cutter movement space of the panel fastening unit.

The duplex partially cutting apparatus further comprises a seal curing unit disposed at the frame. The seal curing unit has: a dispensing component disposed above the panel fastening unit; a curing component disposed above the panel fastening unit; and a seal curing unit driver electrically connected to the dispensing component and the curing component to drive the dispensing component and the curing component to move horizontally and vertically within the cutter movement space of the panel fastening unit.

As regards the duplex partially cutting apparatus, the orientation of the electrostatic fans is adjustable.

As regards the duplex partially cutting apparatus, the first cutter does not correspond in position to the second cutter.

In conclusion, the present invention provides a duplex partially cutting apparatus equipped with a first partial cutting unit and a second partial cutting unit to allow a user to partially cut a panel from above and below to thereby reduce the instances of panel alignment, preclude alignment-induced errors, and speed up the manufacturing process. Furthermore, the duplex partially cutting apparatus is equipped with electrostatic fans for clearing the panel of impurities and dust.

### BRIEF DESCRIPTION

Objectives, features, and advantages of the present invention are hereunder illustrated with specific embodiments in conjunction with the accompanying drawings, in which:

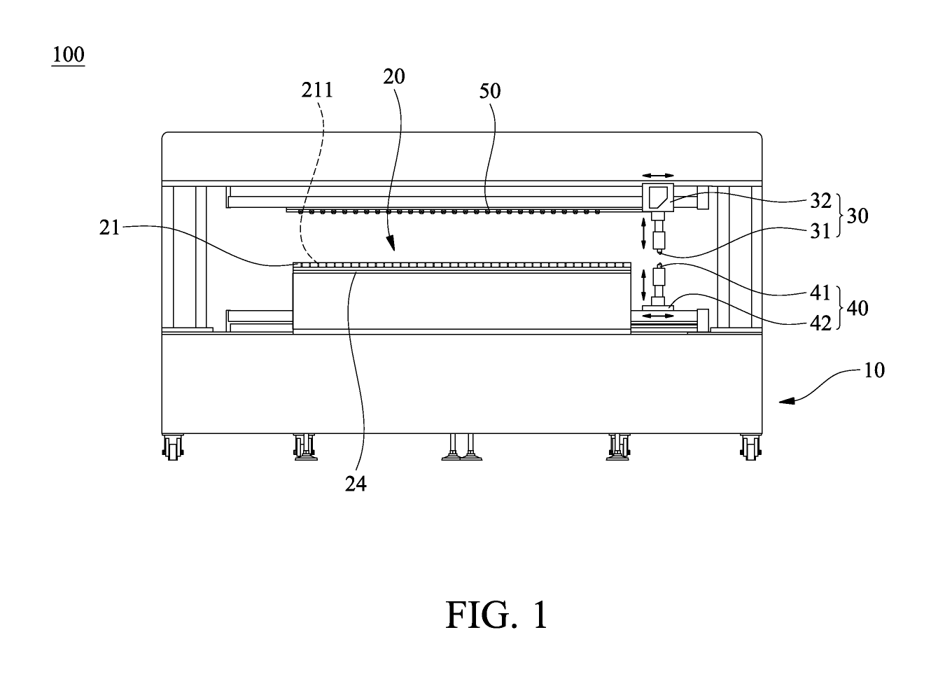

FIG. 1 is a front view of a duplex partially cutting apparatus according to the first specific embodiment of the present invention;

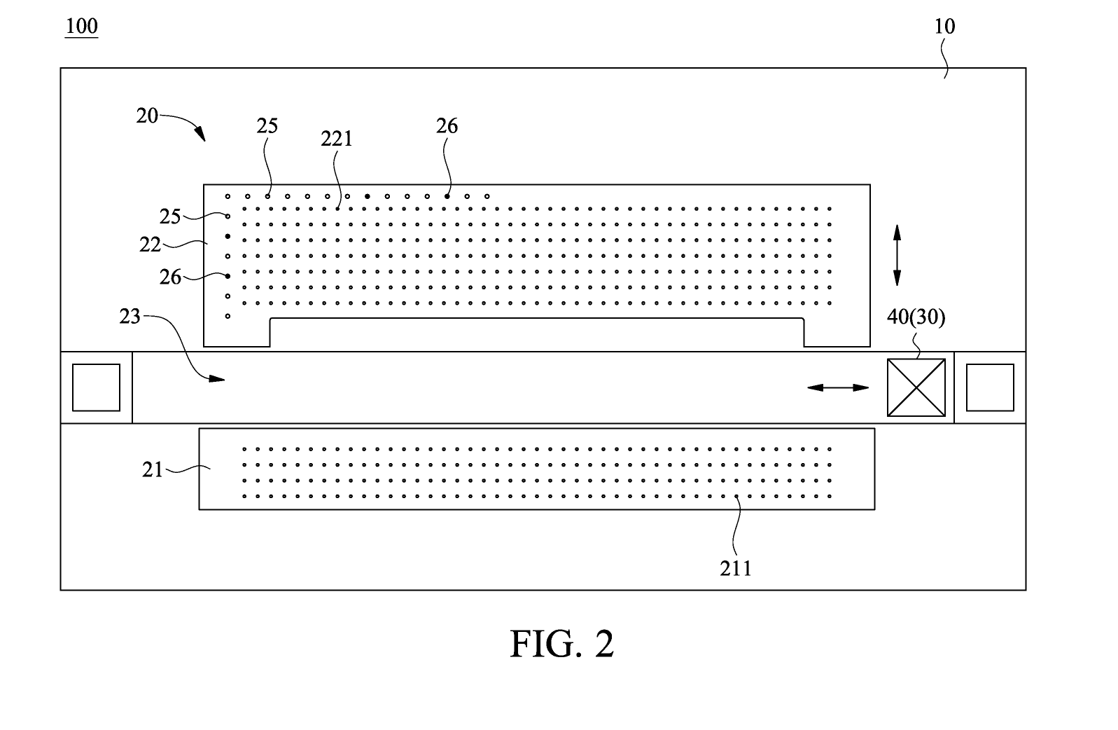

FIG. 2 is a top view of a panel fastening unit, a first partial cutting unit and a second partial cutting unit of the duplex partially cutting apparatus according to the first specific embodiment of the present invention;

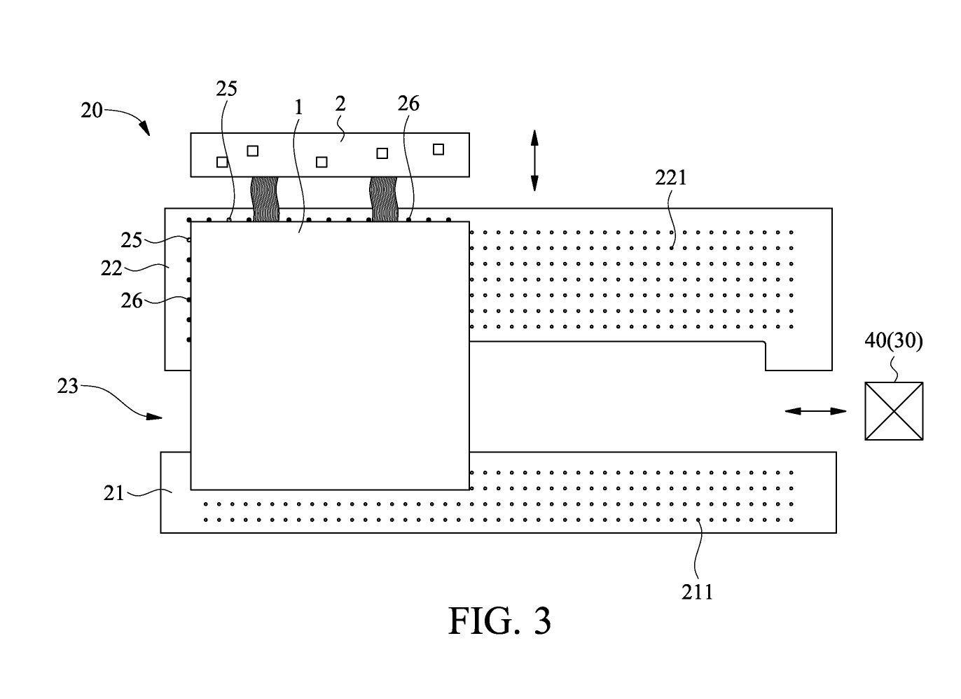

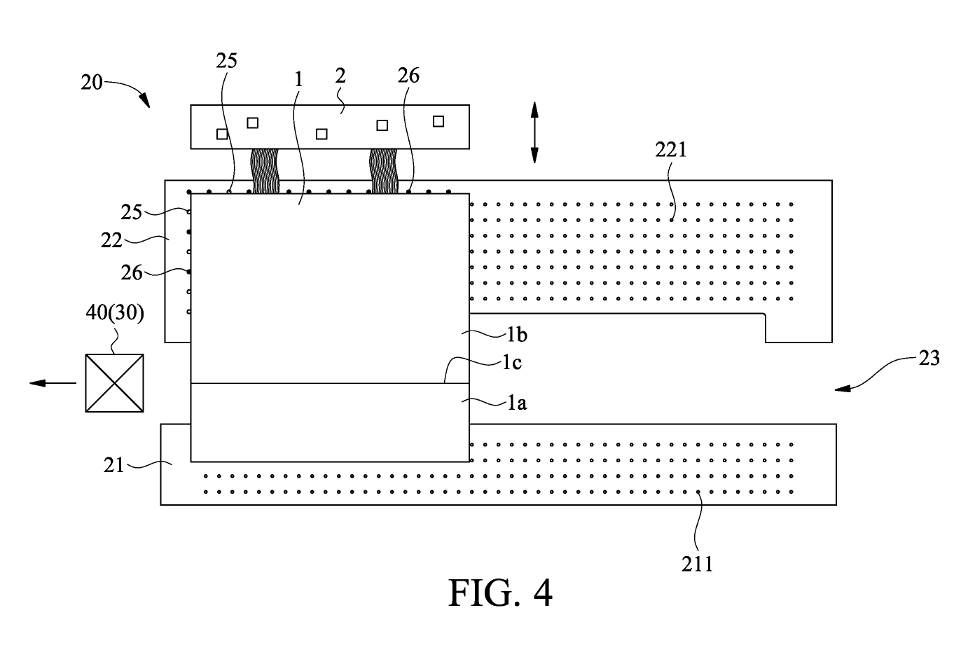

FIG. 3 and FIG. 4 are schematic views of a panel partially cutting process performed with the duplex partially cutting apparatus according to the first specific embodiment of the present invention;

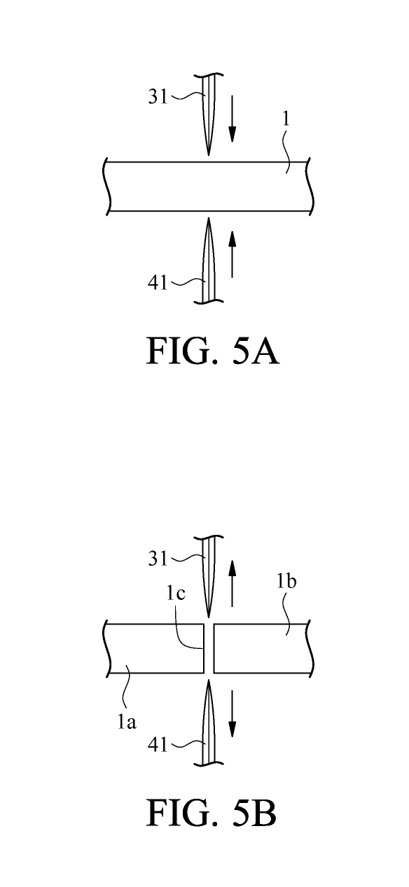

FIG. 5A and FIG. 5B are lateral views of the panel partially cutting process performed with the duplex partially cutting apparatus according to the first specific embodiment of the present invention; and

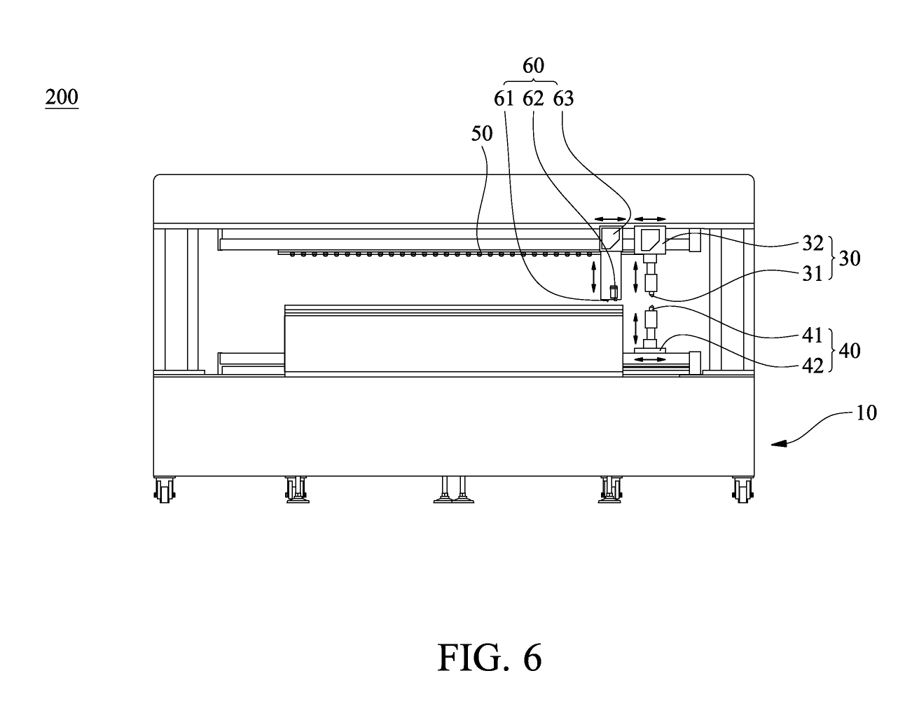

FIG. 6 is a front view of a duplex partially cutting apparatus according to the second specific embodiment of the present invention.

### DETAILED DESCRIPTION

Referring to FIG. 1 and FIG. 2, there are shown a front view and a top view of a duplex partially cutting apparatus 100 according to the first specific embodiment of the present invention, respectively, wherein the front side of the duplex partially cutting apparatus 100 shown in FIG. 2 faces downward. The duplex partially cutting apparatus 100 cuts a panel (not shown) from above and below. The duplex partially cutting apparatus 100 comprises a frame 10, a panel fastening unit 20, a first partial cutting unit 30, a second partial cutting unit 40, and a plurality of electrostatic fans 50.

The panel fastening unit 20 is disposed on the frame 10. The panel fastening unit 20 has a first platform 21, a second platform 22, a cutter movement space 23, a panel sucker 24, at least two positioning element fixing holes 25, at least two panel positioning elements 26, and a platform driver (not shown). A plurality of through holes 211 is disposed across the surface of the first platform 21. The first platform 21 is positioned proximate to the front side of the frame 10. A plurality of through holes 221 is disposed across the surface of the second platform 22. The second platform 22 is positioned proximate to the rear side of the frame 10. The first platform 21 and the second platform 22 are parallel. The cutter movement space 23 is defined by and between the first platform 21 and the second platform 22. The panel sucker 24 is disposed below the first platform 21 and the second platform 22 and is in communication with the through holes 211, 221 so as to be capable of taking a panel by suction and thereby fixing the panel in place on a preliminary basis. The positioning element fixing holes 25 are disposed on the surface of the second platform 22. Preferably, the positioning element fixing holes 25 are disposed at the periphery of the second platform 22 and positioned proximate to the backward left portion of the frame 10. The panel positioning elements 26 are inserted into the positioning element fixing holes 25, respectively, to fix a panel 1 in place (as shown in FIG. 4). The platform driver is electrically connected to the second platform 22 to drive the second platform 22 to move forward and backward. Hence, when driven by the platform driver, the second platform 22 can move toward the front side or the rear side of the frame 10, as shown in FIG. 2 and FIG. 3. In practice, the panel 1 comes in the form of a liquid crystal display (LCD) panel, an organic light-emitting diode (OLED) panel, or a touch panel (TP).

The first partial cutting unit 30 is disposed on the frame 10. The first partial cutting unit 30 has a first cutter 31 and a first cutter driver 32. The first cutter 31 is disposed above the panel fastening unit 20. The first cutter driver 32 is electrically connected to the first cutter 31 to drive the first cutter 31 to move horizontally and vertically within the cutter movement space 23 of the panel fastening unit 20 and thereby cut the panel from above as shown FIG. 1 and FIG. 2.

The second partial cutting unit 40 is disposed on the frame 10. The second partial cutting unit 40 has a second cutter 41 and a second cutter driver 42. The second cutter 41 is disposed below the panel fastening unit 20. The second cutter 41 corresponds in position to the first cutter 31 as shown FIG. 3. The second cutter driver 42 is electrically connected to the second cutter 41 to drive the second cutter 41 to move horizontally and vertically within the cutter movement space 23 of the panel fastening unit 20 so as to cut partially the panel from below as shown in FIG. 1 and FIG. 2.

The electrostatic fans 50 is disposed on the frame 10 and face the cutter movement space 23 of the panel fastening unit 20. The orientation of the electrostatic fans 50 is adjustable as needed, so as for the electrostatic fans 50 to face the cutting point of the panel 1.

Referring to FIG. 3 and FIG. 4, there are shown schematic views of a panel partially cutting process performed with the duplex partially cutting apparatus according to the first specific embodiment of the present invention.

To cut partially a large-sized panel 1 in order to form panels of specified dimensions, a user places the panel 1 on the panel fastening unit 20 (that is, specifically speaking, on the first platform 21 and the second platform 22) to allow the panel sucker (not shown) to take the panel 1 by suction and thereby fix the panel 1 in place on a preliminary basis. Afterward, panel positioning elements 26 are inserted into positioning element fixing holes 25 of the second platform 22, respectively, so as to fix the panel 1 in place further (that is, specifically speaking, by means of the panel positioning elements 26). Hence, the panel sucker 24 and the panel positioning elements 26 together prevent the panel 1 from shaking while being cut and thus reduce alignment-induced errors. With the platform driver, the user adjusts the position of the second platform 22 and thus changes the position of the panel 1.

After the panel 1 has been fixed in place, the user cuts the panel 1 from above with the first partial cutting unit 30 and cuts the panel 1 from below with the second partial cutting unit 40, by following the three steps described below. First, referring to FIG. 5A, the user allows the first partial cutting unit 30 to descend and the second partial cutting unit 40 to ascend, until both the first partial cutting unit 30 and the second partial cutting unit 40 come into contact with the panel 1. Then, referring to FIG. 3, the first partial cutting unit 30 and the second partial cutting unit 40 move horizontally within the cutter movement space 23 of the panel fastening unit 20 to partially cut the panel 1 simultaneously. Finally, referring to FIG. 4 and FIG. 5B, the user allows the first partial cutting unit 30 to ascend and the second partial cutting unit 40 to descend such that both the first partial cutting unit 30 and the second partial cutting unit 40 are no longer in contact with the panel 1. As a result, the panel 1 is partially cut to form on each of the two opposing sides thereof a cutting groove 1c which divides the panel 1 into a first panel 1a and a second panel 1b. The two cutting grooves 1c are collinear when viewed laterally (as shown in FIG. 5B). The second panel 1b is what the user wants and is of specified dimensions.

During the partial cutting process carried out with the first partial cutting unit 30 and the second partial cutting unit 40, the electrostatic fans (not shown) each blow continuously a current of electrostatic air upon the point of cut to prevent any alignment-induced dust and particles from adhering to the first panel 1a and the second panel 1b.

Furthermore, the operation of the first partial cutting unit 30 and the operation of the second partial cutting unit 40 are not necessarily simultaneous, as it is feasible to cut the panel 1 with the first partial cutting unit 30 partially, and then cut the panel 1 with the second partial cutting unit 40 partially, or vice versa.

At this point in time, the user splits the panel 1, removes the first panel 1a, and seals a cut-created edge of the second panel 1b, wherein the cut-created edge corresponds in position to the two cutting grooves 1c.

In conclusion, a duplex partially cutting apparatus of the present invention partially cuts a panel from above and below without turning over the panel, thereby dispensing the need to align the panel on multiple occasions, preventing alignment-induced errors, increasing yield, and speeding up the partially cutting process.

Persons skilled in the art understand that, it is preferable that the first cutter 31 and the second cutter 41 do not correspond in position to each other (not shown) while cutting the panel 1 partially, such that the cutting grooves 1c which demarcate the first panel 1a and the second panel 1b are no longer collinear when viewed laterally, thereby resulting in two advantages: the user can split the panel 1 easier; and, after the split, the cut-created edge of the second panel 1b is easier to seal, because the cut-created edge has a steplike profile when viewed laterally.

Referring to FIG. 6, there is shown a front view of a duplex partially cutting apparatus 200 according to the second specific embodiment of the present invention. The duplex partially cutting apparatus 200 further comprises a seal curing unit 60 disposed on the frame 10. The seal curing unit 60 has a dispensing component 61, a curing component 62, and a seal curing unit driver 63.

The dispensing component 61 is disposed above the panel fastening unit 20 and corresponds in position to the cutting groove 1c on the panel 1 (as shown in FIG. 5B). The curing component 62 is disposed above the panel fastening unit 20 and corresponds in position to the cutting groove 1c on the panel 1 (as shown in FIG. 5B). The seal curing unit driver 63 is electrically connected to the dispensing component 61 and the curing component 62 to drive the dispensing component 61 and the curing component 62 to move horizontally and vertically within the cutter movement space 23 of the panel fastening unit 20. After the panel 1 has been partially cut with the first partial cutting unit 30 and the second partial cutting unit 40 and split, the seal curing unit 60 can seal the second panel 1b directly, thereby dispensing the need to align the second panel 1b again; hence, the duplex partially cutting apparatus of the present invention is advantageously conducive to reducing alignment-induced errors, enhancing the yield, and speeding up the panel partially cutting process.

In conclusion, a duplex partially cutting apparatus of the present invention partially cuts a panel from above and below without turning over the panel, thereby dispensing the need to align the panel on multiple occasions, preventing alignment-induced errors, increasing yield, and speeding up the partially cutting process. Furthermore, with the panel lying flat on the panel fastening unit, the surface of the panel is unlikely to be subjected to compression when the panel is fixed in place by means of the panel sucker and the panel positioning elements, and in consequence the surface of the panel is protected against damage.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A duplex partially cutting apparatus for cutting partially a panel from above and below, the duplex partially cutting apparatus comprising:
a frame;
a panel fastening unit disposed on the frame and having:
a first platform having thereon a plurality of through holes and being positioned proximate to a front side of the frame;
a second platform having thereon a plurality of through holes and being positioned proximate to a rear side of the frame;
a cutter movement space defined between the first platform and the second platform;
a panel sucker disposed below the first platform and the second platform and being in communication with the through holes to take the panel by suction;
at least two positioning element fixing holes disposed on the second platform;
at least two panel positioning elements inserted into the positioning element fixing holes, respectively, to fix the panel in place; and
a platform driver electrically connected to the second platform to drive the second platform to move forward and backward;
a first partial cutting unit disposed on the frame and including:
a first cutter disposed above the panel fastening unit; and
a first cutter driver electrically connected to the first cutter to drive the first cutter to move horizontally and vertically within the cutter movement space of the panel fastening unit;
a second partial cutting unit disposed on the frame and including:
a second cutter disposed below the panel fastening unit and corresponding in position to the first cutter; and
a second cutter driver electrically connected to the second cutter to drive the second cutter to move horizontally and vertically within the cutter movement space of the panel fastening unit; and
a plurality of electrostatic fans disposed on the frame and facing the cutter movement space of the panel fastening unit.

2. The duplex partially cutting apparatus of claim 1, further comprising a seal curing unit disposed at the frame, the seal curing unit having:
a dispensing component disposed above the panel fastening unit;
a curing component disposed above the panel fastening unit; and
a seal curing unit driver electrically connected to the dispensing component and the curing component to drive the dispensing component and the curing component to move horizontally and vertically within the cutter movement space of the panel fastening unit.

3. The duplex partially cutting apparatus of claim 1, wherein orientation of the electrostatic fans is adjustable.

4. The duplex partially cutting apparatus of claim 2, wherein orientation of the electrostatic fans is adjustable.

5. The duplex partially cutting apparatus of claim 1, wherein the first cutter does not correspond in position to the second cutter.

6. The duplex partially cutting apparatus of claim 2, wherein the first cutter does not correspond in position to the second cutter.

7. The duplex partially cutting apparatus of claim 3, wherein the first cutter does not correspond in position to the second cutter.

8. The duplex partially cutting apparatus of claim 4, wherein the first cutter does not correspond in position to the second cutter.
